(19) United States
(12) Patent Application Publication
(10) Pub. No.: US 2008/0149469 A1
(43) Pub. Date: Jun. 26, 2008

(54) CONFIGURABLE KEYPAD ASSEMBLY AND A KIT THEREFOR

(75) Inventors: Pierre Gaudet, Trois-Rivieres (CA); Bertrand Mallette, Mercier (CA); Luc St-Pierre, Grand-Mere (CA); Mario Gagnon, Ste-Adele (CA); Patrick Mainville, Montreal (CA); Jean-Francois Lebeuf, Brossard (CA)

Correspondence Address: BAKER & HOSTETLER LLP, WASHINGTON SQUARE, SUITE 1100, 1050 CONNECTICUT AVE. N.W., WASHINGTON, DC, 20036-5304, US

(73) Assignee: TELEFLEX MEGATECH INC.

(21) Appl. No.: 11/933,043

(22) Filed: Oct. 31, 2007

Related U.S. Application Data
(60) Provisional application No. 60/855,402, filed on Oct. 31, 2006.

(51) Int. Cl. H01H 13/83

(52) U.S. Cl. 200/5 A

(57) ABSTRACT

A configurable keypad assembly adapted for vehicular controls. A kit for assembling such a configurable keypad is also disclosed. The overlay is provided with identification markings. The keypad assembly includes a configurable keypad circuit provided with a plurality of switches responsive to pressure thereon. The keypad circuit is encased in a flexible sleeve that is shaped to fit over the circuit. The top surface of the sleeve has a number of independently pressable button areas in alignment with the switches, such that any pressure exerted on a given button area activates the switch under it. The assembly also includes means for securing the rigid fascia overlay over the button areas. The identification markings on the overlay, once installed, are in alignment with the button areas. The configurable keypad assembly has the flexibility of being distributed with or without the fascia overlay and can be made waterproof for marine applications.

### CROSS-REFERENCE TO RELATED APPLICATIONS

This application claims priority to U.S. provisional patent application Ser. No. 60/855,402, titled, “Configurable Keypad with Fascia Overlay,” filed Oct. 31, 2006, the disclosure of which is hereby incorporated by reference in its entirety.

### FIELD OF THE INVENTION

The present invention relates to the field of electronic controls and more particularly concerns an easily configurable keypad assembly adapted for vehicular controls. The present invention also concerns a kit for assembling such a configurable keypad.

### BACKGROUND OF THE INVENTION

Buttons and switches are essential components of dashboards of boats, industrial equipment, or land vehicles such as RVs, trucks, buses, tractors, etc. With the advent of multiplexing technology, the possibilities for designing and configuring the look and functionality of such dashboards have become practically endless.

Vehicle manufacturers require control components which are practical and versatile. Keypads, in particular, can advantageously provide several controls grouped on a single control component. The particular combination of functions required on a single component may vary depending on the application. For example, a boat manufacturer may offer several possible control configurations for one or different boat models. It is tedious for such a manufacturer to order different keypads, each with its own part number, for each configuration, which implies managing and keeping track of a complex inventory. It is therefore highly preferred to purchase template keypads, each having the same part number, which can then be configured as desired and then provided with markings identifying the function associated with each control.

Different types of configurable keypads are known in the art, but each presents its own drawbacks.

Mechanical switch keypads generally take the shape of individual rubber buttons projecting out of a plastic housing. Identification is provided on the plastic housing, through an adhesive overlay affixed thereon which is provided with appropriate pictograms and may be back lighted. In this case, the pictogram identifying a given control is not on the button itself but besides it, which can lead to confusion.

Membrane keypads are also known in the art. A flexible membrane is directly provided with carbon contacts or integrated dome switches. The membrane is permanently held within a rigid frame. Pictograms or other identification markings may be silk-screened or pad printed on the flexible membrane. One drawback of membrane keypads is that they are not reusable, as the functions are integral to the membrane and the identification markings cannot be changed once made.

For typical silicone rubber keypads, a full silicone rubber skin defining the switching surface is provided over a switching printed circuit board (PCB). Generally, the silicone skin is transparent and provided with a white coat of paint to promote light diffusion, and an opaque overcoat. Customization may be provided by laser etching the pictograms directly into the opaque top coat, which can be an expensive process and the required equipment may not be readily available. Alternatively, identification may be provided through labels insertable into pockets positioned either over or besides each button. The result of this embodiment does not however give a fully professional and aesthetically pleasing appearance.

There is therefore a need for a configurable keypad assembly which alleviates the above-mentioned drawbacks.

### SUMMARY OF THE INVENTION

According to a first aspect of the invention, there is provided a configurable keypad assembly for use in combination with a rigid fascia overlay. The overlay is provided with identification markings. The keypad assembly includes a configurable keypad circuit provided with a plurality of switches responsive to pressure thereon. The keypad circuit is encased in a flexible sleeve that is shaped to fit over the circuit. The top surface of the sleeve has a number of independently pressable button areas in alignment with the switches, such that any pressure exerted on a given button area activates the switch under it. The assembly also includes securing means for securing the rigid fascia overlay over the button areas. The identification markings on the overlay, once installed, are in alignment with the button areas.

Such an assembly can be easily reconfigured with a different fascia overlay. Consequently, inventories for keypad assemblies can be rationalized as a same basic keypad circuit can be used in several different applications and sold to different clients. A customized overlay can then be installed on the keypad assembly for a specific application or according to a specific client requirement.

In accordance with another embodiment of the present invention, there is also provided a kit for assembling a configurable keypad assembly with a fascia overlay as defined above.

Consequently, the configurable keypad assembly has the flexibility of being distributed to customers with or without the fascia overlay. Furthermore, the keypad assembly is designed in a manner that makes it suitable for environments that require waterproof electronic controls, such as in marine applications.

Other features and advantages of the present invention will be better understood upon reading of preferred embodiments thereof with reference to the appended drawings.

### BRIEF DESCRIPTION OF THE DRAWINGS

FIG. 1 is a partially exploded perspective view of a keypad assembly including a keypad and fascia overlay according to an embodiment of the invention.

FIG. 2 is a perspective view of the keypad of FIG. 1 without the fascia.

FIG. 3 is a perspective view of the keypad of FIG. 1 with the fascia mounted thereon.

FIG. 4 is a top view in partial transparency of the keypad of FIG. 2.

FIG. 5 is a front view in partial transparency of the keypad of FIG. 2.

FIG. 6 is a side view in partial transparency of the keypad of FIG. 2.

FIG. 7 is a top view of a keypad according to another embodiment of the invention.

FIG. 8 is a perspective view of the keypad of FIG. 7.

FIG. 9 is a top view in partial transparency of the keypad of FIG. 7.

FIG. 10 is a front view of the keypad of FIG. 7.

FIG. 11A is a side view of the keypad of FIG. 7; FIG. 11B is a same view as FIG. 11A in transparency.

### DESCRIPTION OF PREFERRED EMBODIMENTS OF THE INVENTION

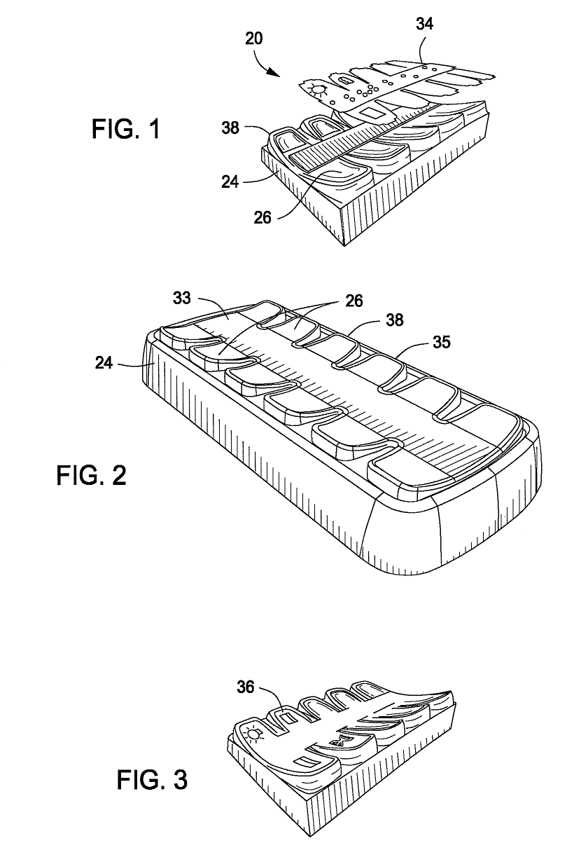

Referring to FIGS. 1 to 6 there is shown a keypad assembly 20 according to a preferred embodiment of the present invention.

The keypad assembly 20 may be used in any context where traditional keypads, such as of the mechanical switching, membrane and rubber types mentioned above are found useful. It is an advantageous aspect of the keypad assembly of the present invention that it may be easily made waterproof, making it particularly adapted for marine applications. Its usefulness is not however limited to such applications and its use could also be contemplated for industrial equipment, or land vehicles such as RVs, trucks, buses, tractors, etc.

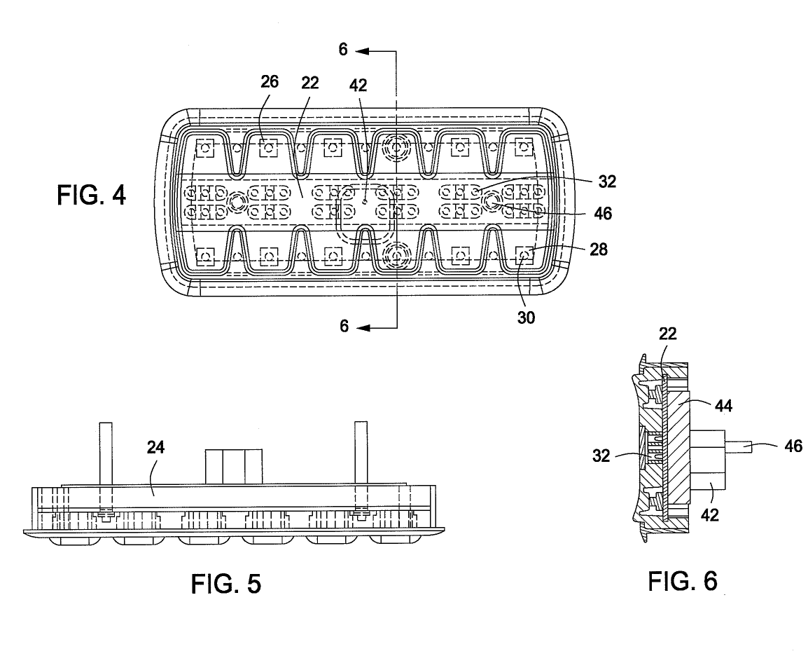

The keypad assembly 20 first includes a configurable keypad circuit 22 (see FIG. 4). The keypad circuit 22 may be of any traditional or appropriate construction and may be embodied by a PCB such as used for typical rubber type keypads. The keypad circuit 22 therefore includes a plurality of switches 28 responsive to pressure thereon, such as dome or tact-type switches. Each switch 28 is associated with a particular function, as is well known in the art. The keypad circuit 22 is preferably also provided with backlighting elements 30 aligned with the pressure switches and status indicating lights 32. As shown in FIG. 6, an appropriate connector 42 may project from the rear surface of the keypad circuit 22 for connection to a multiplexing network, as is well known in the art. The rear surface of the keypad circuit 22 is preferably affixed to a waterproof support 44, which is for example made of plastic, and retained thereon through retaining pins 46. The control circuit may optionally be programmable.

As shown in FIG. 2, the keypad assembly 20 further includes a flexible sleeve 24, preferably made of silicone, which is shaped to fit over, encase and surround the keypad circuit 20 except on its back side. The flexible sleeve 24 has button areas 26 distributed on a top surface thereof. In the preferred embodiment, it has been found advantageous for the button areas to be of a size comparable with the end of a finger or slightly larger, to facilitate the interfacing with a user. Alternatively, smaller or larger button areas 26 may be considered depending on a given application. The button areas 26 are operationally aligned with the pressure switches, so that pressing on a given button area 26 will in turn apply a pressure on a corresponding switch, as is well known in the art. Preferably, the button areas are defined by raised portions of the top surface of the sleeve 24. The sleeve 24 is also preferably attached to the support 44 in a waterproof manner.

As mentioned above, the flexible sleeve 24 is preferably made of silicone and of a construction similar to that of traditional rubber-type keypad membranes, Alternatively, the sleeve 24 may be made of any other appropriate flexible material such as rubber or any rubber-like material, such as thermoplastic lassoers (TYPE), thermoplastic polyolefins (TPO), and thermoplastic vulcanizates (TPV). In the preferred embodiment, the flexible sleeve 24 is transparent, and is covered with a light diffusing layer such as a coat of white or light paint. An opaque overcoat is further provided over the light diffusing layer. At least a portion of each button area 26, as well as regions of the sleeve 24 dedicated to status indicators, is left free of the opaque overcoat. The overcoat-free regions may either be provided by masking these regions when applying the opaque overcoat, or by applying the overcoat uniformly over the sleeve and subsequently removing portions thereof.

In the preferred embodiment, the flexible sleeve fits snugly around the keypad circuit 22 and its support 44, and silicone joints are provided at their edges for waterproofing the assembly. Waterproofing may be further completed by pouring urethane inside the assembly to surround the PCB.

As shown in FIGS. 1 and 3, the assembly 20 can be used in combination with a disposable rigid fascia overlay 34 adapted to be attached to the top surface of the flexible sleeve 24. By “rigid”, it is understood that the fascia overlay 34 has a rigidity or stiffness greater than that of the flexible sleeve 24, and it will be understood by one skilled in the art that it may have a certain degree of flexibility without departing from the scope of the present invention. The fascia overlay 34 is provided with identification markings 36 distributed so that they are superposed on the button areas 26 when the fascia overlay 34 is properly positioned on the flexible sleeve 24. Each identification marking 36 is therefore selected to identify the function of the pressure switch associated with the corresponding button area 26. Securing means 35 are provided on the assembly 20 for securing the fascia overlay 34 on the top surface of the sleeve 24.

Preferably, the fascia overlay 34 is made of polycarbonate, a combination of polycarbonate and polyester, or any other suitable material or combination of materials. Such fascias are well known and readily available. The identification markings 36 can be silk-screened or pad printed on the fascia overlay 34, such processes being well known and easily accessible to vehicle manufacturers or the like. The identification markings 36 may be pictograms, lettering or any symbol generally allowing the identification of the function of a given switch by its user.

The fascia overlay 34 and flexible sleeve 24 are preferably designed so that the former snugly fits onto the latter. In one embodiment of the securing means mentioned above, the flexible sleeve 24 preferably has a ridge 38 on its top surface following the shape of the fascia overlay 34 to help retain it in place. The ridge 38 is made integral to the sleeve 24. The ridge 38 and the button areas thus define a space for receiving the overlay through a pressfit connection. The fascia overlay is however preferably also secured to the flexible sleeve through an appropriate adhesive. In a particularly advantageous embodiment, an adhering strip 40 is provided on the flexible sleeve 24, preferably in proximity of the button areas 26. The adhering strip 40 can for example be made of acrylic and polycarbonate. In this embodiment, the adhering strip provides a better adherence for traditional fascia materials and adhesives, which can be difficult to retain on the some materials such as silicone.

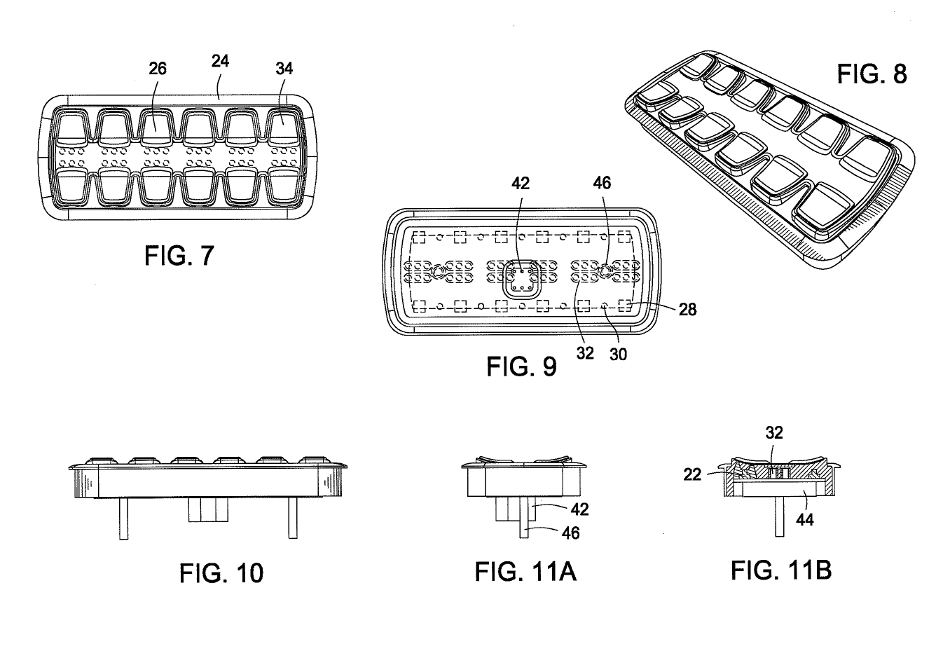

In the embodiment of FIGS. 1 to 3, the button areas 26 are distributed in two rows and the adhering strip 40 is positioned between these rows. The flexible sleeve thus has a central support structure 33 with the button areas extending laterally from the support structure 33. The fascia overlay 34 is itself shaped as a strip from which project fingers corresponding to the button areas. In an alternative embodiment, the fascia overlay 34 may be separated into a plurality of components. According to one embodiment, the fascia overlay may be cut into pairs of fingers held together by a portion of the middle strip. Alternatively, a separate fascia overlay may be provided for each button area 26 of the flexible sleeve 24 as shown in FIGS. 7 to 11B.

In alternative embodiments, the fascia overlay may be attached to the flexible sleeve through a number of different techniques. For example, one or more small pins, or any other type of fasteners for mechanically fastening the overlay to the sleeve, may be used. In another case, if thermoplastic materials are used for making the sleeve, the overlay may be overmolded onto the sleeve.

It is one advantage of the present invention that the resulting keypad combines the advantages of both rigid and flexible materials. The flexible sleeve is highly deformable and provides a lot of travel, more than traditional membrane keypads. The fascia overlay however provides rigidity in the button areas to increase the effective activation surface. This opens the way to various button geometries and allows to provide three-dimensional contours without limiting the activation surface. The end result is a product which is versatile and provides more freedom of design than either types of traditional keypads.

As mentioned above, as shown in FIG. 4, the keypad circuit 22 is preferably provided with illumination devices, such as LEDs or other light fixtures, acting both as back-lighting elements 30 and status indicators 32. The backlighting elements are aligned with the translucid button areas 26 so that they are uniformly illuminated. Preferably, the flexible sleeve 24 is moulded with light tunnels therein in alignment with the status indicators 32 to guide light thereof at a precise point on the surface of the sleeve 24. The identifying marking 36 on the fascia overlay 34 preferably let the backlight therethrough while the rest of the overlay remain opaque, making the marking appear as a light element. Edge lighting may also be provided to facilitate the identification of the button areas 26. Of course, transfused portions may also be provided on the fascia overlay in alignment with the status indicators 32 to let the light thereof through. The appearance of the light elements may vary in daytime or nighttime mode.

According to other embodiments of the invention, each button area 26 may have its own fascia overlay 34. In a first such embodiment, the identification markings 36 are directly formed into the fascia overlays 34. In a second such embodiment, the identification markings 36 are masked on the fascia overlay 34, making the entire button areas 26 appear lighted except in regions where the marking are made.

As mentioned previously, in accordance with another embodiment of the present invention, there is also provided a kit for assembling one of the above-mentioned configurable keypad assemblies with a fascia overlay. Kits can be provided for keypad assemblies requiring either a single fascia overlay to be installed over the whole keypad or a plurality of smaller overlays to be installed over corresponding button areas. Therefore, the keypad assembly has the flexibility of being kept in inventory or eventually distributed to customers without the overlays or as kits with different overlays. It will be understood that in this context the customer is not necessarily the end user but may for example be a vehicle manufacturer wishing to incorporate such keypads in its own products.

Of course, numerous modifications could be made to the embodiments above without departing from the scope of the present invention.

1. A configurable keypad assembly for use in combination with a rigid fascia overlay provided with identification markings, said keypad assembly comprising:
a configurable keypad circuit comprising a plurality of switches responsive to pressure thereon;
a flexible sleeve shaped to fit over and laterally encase the keypad circuit, said sleeve having a top surface defining a plurality of independently pressable button areas each in register with a corresponding one of the plurality of switches, such that pressing on a given button area activates the corresponding one of the plurality of switches; and
securing means for securing the rigid fascia overlay over the plurality of button areas with said identification markings in register with said button areas.

2. The configurable keypad assembly according to claim 1, wherein the securing means comprise a ridge integral to said sleeve and projecting over said top surface, said ridge and plurality of button areas defining a fascia-receiving space shaped to pressfittedly receive the fascia overlay.

3. The configurable keypad assembly according to claim 1, wherein the top surface of the flexible sleeve further comprises a central support structure, said plurality of button areas extending laterally from said support structure.

4. The configurable keypad assembly according to claim 3, wherein said securing means comprise an adhering strip positioned on said central support structure.

5. The configurable keypad assembly according to claim 1, wherein the flexible sleeve is made of silicone.

6. The configurable keypad assembly according to claim 1, wherein each of said button areas is defined by a raised portion of said top surface.

7. The configurable keypad assembly according to claim 1, further comprising:
a support having a top and a bottom face, the keypad circuit being mounted on said top face of the support; and
a connector projecting from said bottom surface of the support for providing a connection to the keypad circuit;
wherein the flexible sleeve is attached to the support in a waterproof manner.

8. The configurable keypad assembly according to claim 1, wherein portions of the keypad circuit are covered with urethane.

9. The configurable keypad assembly according to claim 1, further comprising a plurality of illumination devices each in association and alignment with a corresponding one of the button areas for illumination thereof.

10. The configurable keypad assembly according to claim 9, wherein each of said illumination devices comprises a backlighting element and a status indicator.

11. The configurable keypad assembly according to claim 10, wherein the sleeve further comprises a plurality of light tunnels each in association with one of the status indicators.

12. A configurable keypad assembly kit comprising:
a configurable keypad circuit comprising a plurality of switches responsive to pressure thereon;
a flexible sleeve shaped to fit over and laterally encase the keypad circuit, said sleeve having a top surface defining a plurality of independently pressable button areas each in register with a corresponding one of the plurality of switches, such that pressing on a given button area activates the corresponding one of the plurality of switches;
at least one rigid fascia overlay provided with identification markings; and-securing means for securing the rigid fascia overlay over the plurality of button areas with said identification markings in register with said button areas.

13. The configurable keypad assembly kit according to claim 12, wherein the securing means comprise a ridge integral to said sleeve and projecting over said top surface, said ridge and plurality of button areas defining a fascia-receiving space shaped to pressfittedly receive the fascia overlay.

14. The configurable keypad assembly kit according to claim 12, wherein the top surface of the flexible sleeve further comprises a central support structure, said plurality of button areas extending laterally from said support structure.

15. The configurable keypad assembly kit according to claim 14, wherein said securing means comprise an adhering strip positioned on said central support structure.

16. The configurable keypad assembly kit according to claim 12, wherein the flexible sleeve is made of silicone.

17. The configurable keypad assembly kit according to claim 12, wherein each of said button areas is defined by a raised portion of said top surface.

18. The configurable keypad assembly kit according to claim 12, further comprising:
a support having a top and a bottom face, the keypad circuit being mounted on said top face of the support; and
a connector projecting from said bottom surface of the support for providing a connection to the keypad circuit wherein the flexible sleeve is attached to the support in a waterproof manner.

19. The configurable keypad assembly kit according to claim 12, wherein portions of the keypad circuit are covered with urethane.

20. The configurable keypad assembly kit according to claim 12, further comprising a plurality of illumination devices each in association and alignment with a corresponding one of the button areas for illumination thereof.

21. The configurable keypad assembly kit according to claim 20, wherein each of said illumination devices comprises a backlighting element and a status indicator.

22. The configurable keypad assembly kit according to claim 21, wherein the sleeve further comprises a plurality of light tunnels each in association with one of the status indicators.

23. The configurable keypad assembly kit according to claim 14, wherein the at least one fascia overlay comprises a central strip with a plurality of fingers extending laterally from said central strip.

24. The configurable keypad assembly kit of claim 12, wherein the at least one fascia overlay is made from a material selected from the group consisting of polycarbonate and a combination of polycarbonate and polyester.

25. A configurable keypad assembly kit comprising:
a configurable keypad circuit comprising a plurality of switches responsive to pressure thereon;
a flexible sleeve shaped to fit over and laterally encase the keypad circuit, said sleeve having a top surface defining a plurality of independently pressable button areas each in register with a corresponding one of the plurality of switches, such that pressing on a given button area activates the corresponding one of the plurality of switches;
a plurality of rigid fascia overlays provided with identification markings for assembly on the top surface of the sleeve, each of said plurality of rigid fascia overlays being securable to a corresponding subset of said plurality of button area; and
securing means for securing the plurality of fascia overlays over the plurality of button areas.
